(19) United States
(12) Patent Application Publication
(10) Pub. No.: US 2025/0103294 A1
(43) Pub. Date: Mar. 27, 2025

(54) Analog Inference Circuits, Systems, and Methods

(71) Applicant: TDK Corporation, Tokyo (JP)

(72) Inventor: Rakesh Sethi, San Jose, CA (US)

(73) Assignee: TDK Corporation, Tokyo (JP)

(21) Appl. No.: 18/894,829

(22) Filed: Sep. 24, 2024

Related U.S. Application Data
(60) Provisional application No. 63/585,566, filed on Sep. 26, 2023.

(51) Int. Cl. G06F 7/544; G06F 7/50; G06F 7/523

(52) U.S. Cl. CPC G06F 7/5443; G06F 7/50; G06F 7/523

(57) ABSTRACT

An example system includes an array of input nodes that includes a first input node and a second input node. The system also includes a set of multiply accumulate compute (MAC) components coupled to the first and second input nodes and configured to multiply and accumulate the first analog output and the second analog output. The system further includes a classification component coupled to an output of the set of MAC components and configured to classify the outputs of the set of MAC components. The first input node includes a first sensor configured to output a first analog signal according to changes in an external environment and a first analog frontend configured to generate a first analog output corresponding to the first analog signal. The second input node includes a second sensor and a second analog frontend configured to generate a second analog output corresponding to the second analog signal.

### PRIORITY AND RELATED APPLICATIONS

This application claims priority to U.S. Provisional Patent Ser. No. 63/585,566, filed Sep. 26, 2023, entitled “A low power analog inference circuit with passive storage and compute system,” which is incorporated by reference herein in its entirety.

### TECHNICAL FIELD

This application relates generally to classification of sensor data, including but not limited to, circuits and methods for analog inference.

### BACKGROUND

Machine learning systems use neuron elements to gather various inputs and provide inferences based on the inputs and weights associated with an appropriate bias. The summed inputs may be fed into a filter (e.g., a software or hardware filter). The output of the filter allows for a classification engine to distinguish the presence or absence of an object of interest. Such machine learning systems generally require a large computing resource to compute with a high degree of confidence. For systems that have low power budgets and/or lack reliable connectivity, more and more decisions are needed at an edge device. In some systems, the training of the model using sparse or dense data is performed in a compute-intensive environment and then the resulting weights are transferred to the edge device. However, such systems are configured to utilize digital inputs and may have unacceptably high latency, power, and/or area requirements.

Many sensors generate an analog signal (e.g., an alternating current (AC) analog signal) that has information encoded about a sensed object. The signals may be complex as each may contain information about multiple aspects/parameters of the sensed object. Conventional methods for generating inferences involve gathering the data from the sensors and sending the data to an analog-to-digital converter (ADC). The resulting digital signals are stored, manipulated, and analyzed using a neural network (e.g., a deep neural network (DNN) such as a convolution neural network (CNN)). However, such systems require significant power and area (e.g., for the ADC and digital logic blocks) and introduce significant latency into the inference calculation (e.g., more than 100 milliseconds (ms)).

### SUMMARY

The present disclosure describes amongst other things, an inference system that operates on the analog signals from the sensors (e.g., without using ADCs). For example, a sensor node (also sometimes referred to as an input node or sensor module) of the present disclosure includes an alternating current to direct current (AC/DC) transformer and a spiking circuit, where the spikes output by the spiking circuit correspond to aspects/parameters of the sensed object. The output spikes may have varying DC levels that indicate the aspects/parameters of the sensed object. The output spikes may be input into an inference engine that includes one or more multiply accumulate compute (MAC) component(s) and a classification component. Providing analog spikes to the inference engine reduces the inference latency and can reduce both the power and area needed for the inference engine. The systems described herein are capable of providing a lower power conversion from an analog sensor signal to an ML input as compared to conventional systems that use ADCs. The sensor nodes described herein may be considered as neurons in an ML system that provide spikes for use in generating inferences from the sensor data. Additionally, the cost function calculation for such systems may be performed in near real time (e.g., with a latency of less than 1 ms, 10 ms, or 100 ms).

In accordance with some embodiments, a system includes: (i) an array of input nodes comprising a first input node and a second input node; (ii) a set of MAC components coupled to the first input node and the second input node and configured to multiply and accumulate the first analog output and the second analog output; and (iii) a classification component coupled to one or more outputs of the set of MAC components and configured to classify the one or more outputs of the set of MAC components. The first input node includes a first sensor configured to output a first analog signal according to changes in an external environment, and a first analog frontend coupled to the first sensor and configured to generate a first analog output corresponding to the first analog signal. The second input node includes a second sensor configured to output a second analog signal according to changes in the external environment, and a second analog frontend coupled to the second sensor and configured to generate a second analog output corresponding to the second analog signal.

In accordance with some embodiments, a sensor node includes: (i) a sensor configured to sense a property of a target object and output a corresponding analog signal; (ii) a transformer coupled to the sensor and configured to adjust a voltage or current level of the corresponding analog signal from the sensor; and (iii) a spiking circuit coupled to the transformer and configured to generate a voltage or current spike corresponding to the corresponding analog signal.

In accordance with some embodiments, a method includes: (i) receiving a first analog signal from a first sensor; (ii) receiving a second analog signal from a second sensor; (iii) generating, via a first analog component, a first analog output based on the first analog signal; (iv) generating, via a second analog component, a second analog output based on the second analog signal; (v) generating, via a MAC component, a compute signal by multiplying and accumulating the first analog output and the second analog output; (vi) determining a state of an object based on the compute signal; and (vii) initiating an action based on the state of the object.

Thus, devices and systems are disclosed with methods for obtaining, analyzing, and/or classifying analog sensor data. Such methods, devices, and systems may complement or replace conventional methods, devices, and systems for obtaining, analyzing, and classifying sensor data.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1A illustrates an example sensor module in accordance with some embodiments.

FIG. 1B illustrates an example analog classification circuit in accordance with some embodiments.

FIG. 2 illustrates example inference components in accordance with some embodiments.

FIG. 3 is a flow diagram illustrating an example method for determining and reacting to a state of an object in accordance with some embodiments.

In accordance with common practice, the various features illustrated in the drawings are not necessarily drawn to scale, and like reference numerals can be used to denote like features throughout the specification and figures.

### DESCRIPTION OF EMBODIMENTS

As described in the Background section above, conventional ML systems utilize ADCs to digitize analog sensor output signals. Such systems use large blocks of digital gates as well as memory blocks. The total compute latency of such systems may be in the order of several hundred milliseconds or several seconds.

Conversely, the analog systems described herein can use discretized analog levels generated using a spiking circuit. The discretized analog signals may be stored using a capacitor (e.g., that has robust temperature characteristics and lower noise levels) or other memory component (e.g., erasable programmable read-only memory (EEPROM)). The discretized analog signals may be used as weights for an ML system. In this way, the number of weights generated/used may be less and the latency of the system may be lower (e.g., several milliseconds or tens of milliseconds). Additionally, the systems described herein may have lower digital noise, consume less power, and require less components (e.g., a lower bill of materials) as compared to the conventional systems.

As mentioned in the Summary section above, a sensor module (e.g., an energy harvesting sensor module) of the present disclosure may include a sensor configured to output an analog signal corresponding to changes in an object and/or environment. The sensor module may include an analog frontend configured to convert the analog signal from the sensor to a set of analog spikes (e.g., using a transformer, a rectifier, and a spiking circuit). Some embodiments include an array of sensor modules (sometimes referred to as analog neurons) that generate analog signals in response to various sensor inputs. The analog spikes can be input directly to a machine learning (ML) model (e.g., a CNN), where the amplitude of each spike may be used as a weight for the corresponding input. The analog spikes may be stored prior to being input into the ML model (e.g., using a capacitor or volatile or non-volatile memory). The array of sensor modules provide a low power design for providing inputs/weights to the ML model. Additionally, an initial state for the ML model (e.g., weights for each sensor module) may be stored and adjusted before use, thereby providing self-repairing functionality.

An example sensor may be a piezoelectric element that generates an AC signal according to a detected impulse. The AC signal may be converted to a DC signal and/or rectified and used to generate DC spikes. Each DC spike may be stored in a capacitor (e.g., a capacitor having low temperature dependence, such as a ceramic capacitor). The capacitor may be configured to store the DC spike information for at least a preset amount of time and operate within a specific temperature range. The capacitor may be read to obtain a weight corresponding to the sensor, which is input into an edge compute block (e.g., a MAC component). The edge compute block may also obtain a ground truth, a bias, and/or information from a learned memory database. In some embodiments, a filter is applied to the data to calculate a loss function. A difference of the loss function may be used to adjust one or more weights. Using trained data on an edge compute block with an array of sensor module, as described above, allows for a fully analog ML system (e.g., a fully analog neural network implementation), which can be implemented within an edge device (e.g., an edge inference system).

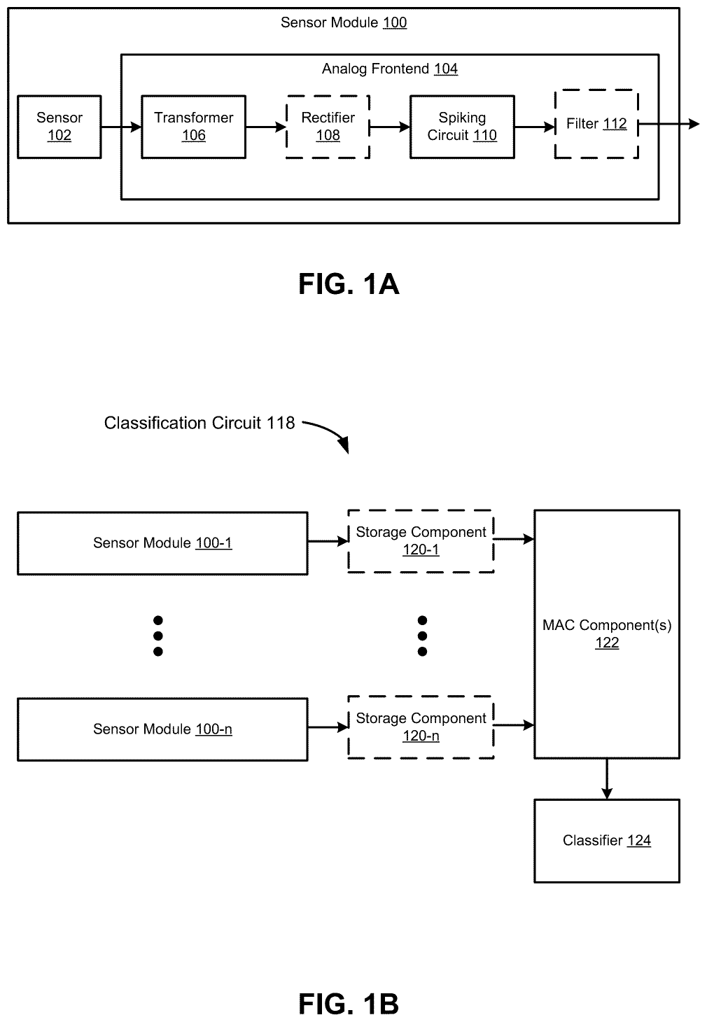

FIG. 1A illustrates a sensor module 100 in accordance with some embodiments. The sensor module 100 includes a sensor 102 and an analog frontend 104. The sensor 102 may be a strain sensor, a magnetoresistive sensor, an infrared sensor, a vibration sensor, a temperature sensor, an accelerometer, an acoustic sensor, or other type of sensor. The sensor 102 may output one or more analog signals. In some embodiments, the analog frontend 104 consists of a set of passive elements (e.g., a transformer, a rectifier, a spiking circuit, a capacitor, a volatile memory element, and/or a non-volatile memory element). In some embodiments, the sensor 102 is attached, or otherwise coupled to, a vehicle, a tire, or other object.

In some embodiments, the sensor 102 is wirelessly coupled to the analog frontend 104. For example, an array of sensors is coupled to one or more analog frontends via a wireless mesh network (e.g., with signal strength RSS parameters). In some embodiments, data from the array of wireless sensors is passed to one or more spiking circuits and the corresponding weights are stored for subsequent ML processing. In some embodiments, a monitoring system is used to route information from the wireless sensors to an appropriate analog frontend component (e.g., the analog frontend component with the lowest corresponding latency). In some embodiments, the monitoring system is configured to (e.g., via an edge algorithm) determine optimal routes for the sensor data.

In some embodiments, the sensor module 100 further includes a storage component (e.g., a storage component 120). The analog frontend 104 includes a transformer 106 and a spiking circuit 110. In some embodiments, the analog frontend 104 includes a rectifier 108. In some embodiments, the analog frontend 104 includes a filter 112. In some embodiments, the transformer 106 is a stepdown transformer (e.g., configured to convert hundreds of volts into millivolts, volts, or tens of volts). In some embodiments, a voltage divider circuit is used to step down the voltage from the sensor 102 (e.g., in addition to, or alternatively to, using the transformer 106). In some embodiments, the filter 112 is a high pass filter, a band pass filter, or a low pass filter. In some embodiments, the rectifier 108 comprises a set of diodes arranged to convert an AC signal to a DC signal. In some embodiments, the spiking circuit 110 includes one or more of a capacitor, a diode, and a resistor. In some embodiments, the output of the sensor module 100 comprises a peak voltage, a peak-to-peak amplitude, or other voltage or current measurement.

FIG. 1B illustrates an analog classification circuit 118 in accordance with some embodiments. The classification circuit 118 includes a set of sensor modules 100 (e.g., the sensor modules 100-1 through 100-n), one or more MAC components 122, and a classifier 124. In some embodiments, the classification circuit 118 includes a set of storage components 120 (e.g., the storage component 120-1 through 120-n). In some embodiments, the set of storage components 120 includes one or more capacitors and/or other types of storage devices (e.g., non-volatile memory). In some embodiments, the set of storage components 120 are co-located with the sensors of the sensor modules 100 (e.g., to reduce latency and reduce noise introduced into the sensor signals during transmission).

In some embodiments, each of the storage components 120 is coupled to a respective output of a spiking circuit 110 or a filter 112. In some embodiments, the one or more MAC components 122 include a set of one or more multiply blocks and a set of one or more accumulate blocks. In some embodiments, the classifier 124 includes a rectified linear unit (ReLU) or other type of activation function. In some embodiments, the classifier 124 is a subcomponent of the MAC component(s) 122. In some embodiments, the MAC component(s) 122 includes a memory bank (e.g., a volatile or non-volatile memory bank). In some embodiments, the MAC component(s) 122 are configured to refine one or more weights prior to generation of an inference from the one or more weights. The refinement may be based on one or more initial values (e.g., stored in the memory bank).

In some embodiments, the analog classification circuit 118 includes control circuitry (e.g., a controller, microcontroller, or other type of control circuitry). In some embodiments, the MAC component(s) 122 and/or the classifier 124 are implemented on the control circuitry. In some embodiments, the control circuitry is configured to calculate a loss function for the data from the sensor modules 100. In some embodiments, the control circuitry is configured to adjust one or more weights based on the loss function. In some embodiments, the control circuitry is configured to adjust weights for the sensor modules 100 (e.g., reset the weights to previous values, such as values corresponding to an initial state or baseline).

In some embodiments, the classification circuit 118 is coupled to a vehicle (e.g., the sensor modules 100 are configured to sense data relating to the vehicle). In some embodiments, the classification circuit 118 is configured to determine various parameters for the vehicle, such as tire pressure, tire tread, vehicle load, vehicle balancing, and the like, based on the sensor data.

In some embodiments, the sensor modules 100 include one or more primary sensors and one or more reference sensors. In some embodiments, the sensor modules 100 comprise an array of magnetoresistive (xMR) sensors providing continuous time varying analog signals for a near field (or far field) source. In some embodiments, the sensor modules 100 further comprise an array of reference sensors (e.g., configured to provide continuous time varying analog signals from a far field on the near field source). For example, the reference sensors provide an additional set of time varying analog signals. The data from the primary sensors and the reference sensors may be combined (e.g., the signal from the reference sensors is used to remove noise from the primary sensors). In some embodiments, the data from the primary sensors and the reference sensors is combined within an analog frontend (e.g., the data is combined with a summing network and then passed to the spiking circuit 110). In some embodiments, the data from the primary sensors and the reference sensors is combined within the MAC component(s) 122.

In some embodiments, the sensor modules 100 comprise an array of magnetic sensor modules. Tracking magnets from far field or near field is a challenge in a variety of applications. For example, the array of magnetic sensor modules are configured to track an array of magnets (e.g., used as position markers in endoscopes, prosthetics, gloves, robots, AR/VR devices, and the like). The magnetic sensors may be configured to track the dipoles (e.g., with monitoring dipole strength and correcting for the ambient field disturbances). Additionally, the dipole field strength may be digitized (e.g., using the spiking circuit 110) and the corresponding weights may be stored and used to calculate a cost function (e.g., using the ReLU 210). Using an analog inference system (e.g., the classification circuit 118) in this manner can provide an edge device with a model having high accuracy and low latency.

In some embodiments, the sensor modules 100 include two or more different types of sensors. In some embodiments, the sensor modules 100 comprise an array of temperature sensor modules. For example, the sensor modules 100 may include an array of IR sensors configured for continuous temperature monitoring. In some embodiments, the sensor modules 100 further comprises an array of deformation (e.g., strain/stress) sensors. For example, classification circuit 118 is configured to generate a temperature and deformation profile from the sensor data. A temperature and deformation profile provides a real time input to a spiking circuit (e.g., the spiking circuit 110). In some embodiments, an edge inference model (e.g., the classification circuit 118) combines data (e.g., in real time) about abnormal temperature and/or deformation analog signals (e.g., thermal gradient maps and/or piezoelectric membrane resonant frequency shift parameters) to determine wear and tear on a component (e.g., such as a turbine blade or other rotating object).

In some embodiments, the sensor modules 100 comprise an array of acoustic sensors. For example, data from the array of acoustic sensors is used to generate a spatial map of sound intensity in an enclosure. In some embodiments, the various sound intensity within the enclosure is recorded and the spikes (e.g., corresponding of the minimum and/or maximum intensity) are generated and stored. Such an array of acoustic sensors (e.g., inside and outside of the enclosure) can provide near real time inference on the content of the enclosure and/or the ambient sounds around the enclosure.

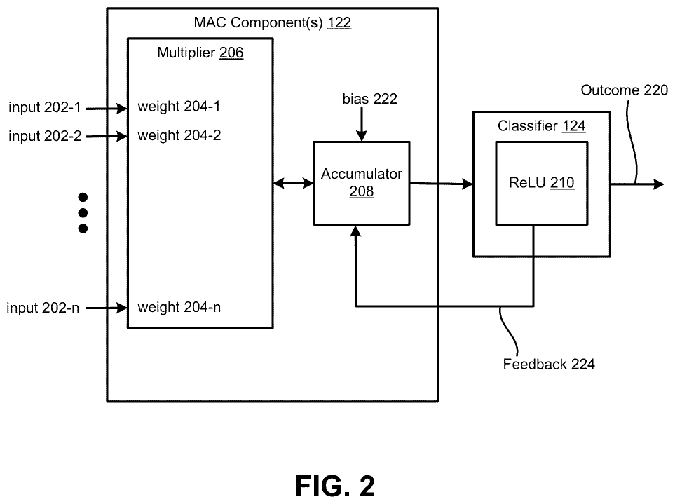

FIG. 2 illustrates example inference components in accordance with some embodiments. In particular, FIG. 2 shows example subcomponents of the MAC component(s) 122 and the classifier 124. In accordance with some embodiments, the MAC component(s) 122 includes a multiplier 206 and an accumulator 208. In some embodiments, the MAC component(s) 122 includes a set of two or more multipliers and/or a set of two or more accumulators. The multiplier 206 receives a set of inputs 202 (e.g., the input 202-1 through 202-n). Although FIG. 2 illustrates the multiplier receiving at least 3 inputs, in some embodiments, the multiplier receives less than 3 inputs. The set of inputs 202 correspond to a set of weights 204 (e.g., the weights 204-1 through 204-n). The set of inputs 202 correspond to spikes from the spiking circuit 110 (e.g., after being filtered and/or stored). In some embodiments, the set of weights 204 correspond to amplitudes of the output spikes from the sensor modules 100. In some embodiments, the multiplier 206 includes one or more weights obtained via training of the MAC component(s) 122. In some embodiments, the multiplier 206 includes one or more weights corresponding to an initial state (e.g., a baseline state) of a sensed object and/or environment. The accumulator 208 in FIG. 2 receives a bias signal 222. In some embodiments, the bias signal 222 is compared with output of the multiplier 206 (e.g., corresponding to the inputs 202) to determine an outcome 220. The classifier 124 in FIG. 2 includes a ReLU 210. In some embodiments, the ReLU 210 is replaced with a different type of activation function (e.g., a sigmoid or hyperbolic tangent activation function). In accordance with some embodiments, the classifier 124 provides feedback 224 to the MAC component(s) 122, which may be used to adjust (e.g., calibrate) weights of the MAC component(s) 122 (e.g., weights of the accumulator 208). In some embodiments, the feedback 224 includes information about an initial state and a current state of a sensor condition).

As an example, the sensor modules 100 may be coupled to a vehicle and/or configured to measure parameters of the vehicle. Equation 1 below illustrates an example MAC computation for the vehicle.

$$Equation 1 - Example MAC computation$$

$$Outcome = \sum K 1 ( vehicle load data ) + K 2 ( tire pressure data ) + K 3 ( vehicle speed data ) + K 4 ( friction data ) + K 5 ( unsprung mass data ) + K 6 ( road condition data )$$

In Equation 1, K1-K6 are weights that are applied to data from the various sensor modules 100. In some embodiments, the weights K1-K6 are updated based on feedback (e.g., the feedback 224). In some embodiments, each vehicle parameter in Equation 1 corresponds to a different sensor module (or set of sensor modules). Equation 1 is intended as an example, and in some embodiments, other MAC computation equations are performed (e.g., with different vehicle parameters).

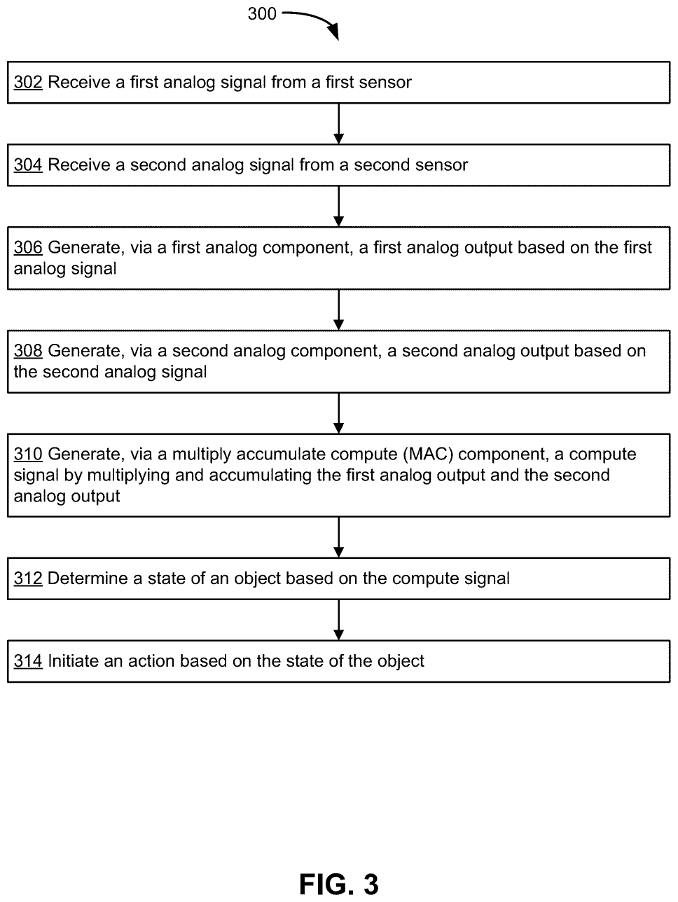

FIG. 3 is a flow diagram illustrating a method 300 determining and reacting to a state of an object in accordance with some embodiments. The method 300 may be performed at a computing system (e.g., comprising the classification circuit 118) having control circuitry and memory storing instructions for execution by the control circuitry. In some embodiments, the method 300 is performed by executing instructions stored in the memory of the computing system.

The system receives (302) a first analog signal from a first sensor (e.g., an instance of the sensor 102). In some embodiments, the first sensor is a first type of sensor (e.g., a strain sensor, a magnetoresistive sensor, an infrared sensor, a vibration sensor, a temperature sensor, an accelerometer, or an acoustic sensor). In some embodiments, the first analog signal corresponds to a sensed object and/or changes in an external environment that includes two or more sensed objects. In some embodiments, the first analog signal corresponds to a first aspect of a sensed object (e.g., a temperature of the object).

The system receives (304) a second analog signal from a second sensor (e.g., an instance of the sensor 102). In some embodiments, the second sensor is a same type of sensor as the first sensor. In some embodiments, the second sensor is a different type of sensor from the first sensor. In some embodiments, the second analog signal corresponds to a second aspect of a sensed object (e.g., a resistance of the object).

The system generates (306), via a first analog component (e.g., an instance of the analog frontend 104), a first analog output based on the first analog signal. In some embodiments, the first analog component includes a transformer (e.g., the transformer 106) and a spiking circuit (e.g., the spiking circuit 110). In some embodiments, the first analog component includes, or is coupled to, a storage element configured to store an output of the first analog component.

The system generates (308), via a second analog component (e.g., an instance of the analog frontend 104), a second analog output based on the second analog signal. In some embodiments, the second analog component includes one or more subcomponents that are not present in the first analog component. For example, the first analog component may include a rectifier (e.g., the rectifier 108) and the second analog component may not include a rectifier. In some embodiments, the second analog component includes one or more operating parameters that differ from operating parameters of the first analog component. For example, the first analog component may have a transformer configured to convert hundreds of volts into a range of millivolts, volts, and/or tens of volts (e.g., a range of 0.5 volts to 10 volts) whereas the second analog component may have a transformer configured to convert thousands of volts into a range of millivolts, volts, and/or tens of volts (e.g., a range of 0.5 volts to 10 volts). In some embodiments, the second analog component includes, or is coupled to, a storage element configured to store an output of the second analog component.

The system generates (310), via a MAC component (e.g., the MAC component(s) 122), a compute signal (e.g., the outcome 220) by multiplying and accumulating the first analog output (e.g., corresponding to the input 202-1) and the second analog output (e.g., corresponding to the input 204-2). In some embodiments, the MAC component compares the information from the first and second analog outputs with bias information (e.g., the bias signal 222) to obtain the compute signal. In some embodiments, the system updates one or more parameters (e.g., weights) of the MAC component based on the compute signal (e.g., using the feedback 224).

The system determines (312) a state of an object (and/or an external environment) based on the compute signal. For example, the system determines a state of a vehicle, a tire, a surface, or other type of object based on the compute signal. In some embodiments, the system determines a state of an external environment (e.g., driving conditions, visibility, or other environmental states).

The system initiates (314) an action based on the state of the object. For example, if the object is a vehicle, the action may be to increase speed, decrease speed, and/or adjust acceleration of the vehicle. In some embodiments, initiating the action includes generating a notification to a user (e.g., indicating the state of the object and, optionally, one or more recommended actions for the user). In some embodiments, the state of the object is determined to be safe or unsafe and the system initiates the action based on determining that the state of the object is unsafe.

Although FIG. 3 illustrates a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

In light of the above disclosure, certain embodiments are described below.

In some embodiments, a sensor module includes a first type of sensor (e.g., a piezoelectric energy harvesting sensor), a transformer (e.g., a 100 volt (V) to 10 V transformer), a rectifier (also sometimes referred to as a rectifier bridge), and a spiking circuit. In some embodiments, the sensor module includes, or is communicatively coupled to, a compute block (e.g., a MAC component). In some embodiments, a voltage divider circuit is used to step down a voltage from the sensor (e.g., instead of the transformer). In some embodiments, an array of sensor modules are coupled to a compute component via a storage device, such as a capacitor. In some embodiments, outputs of the storage device are provided to the compute component, along with trained data sets (e.g., labeled spike level data). In some embodiments, the compute component is configured to compare the sensor data from the storage device with the trained data sets (e.g., using a neural network) to provide an inference.

(A1) In one aspect, some embodiments include a system that comprises: (i) an array of input nodes (e.g., the sensor modules 100) comprising a first input node (e.g., the sensor module 100-1) and a second input node (e.g., the sensor module 100-2); (ii) a set of MAC components (e.g., the MAC component(s) 122) coupled to the first input node and the second input node and configured to multiply and accumulate the first analog output and the second analog output; and (iii) a classification component (e.g., the classifier 124) coupled to one or more outputs of the set of MAC components and configured to classify the one or more outputs of the set of MAC components. The first input node comprises: a first sensor (e.g., the sensor 102) configured to output a first analog signal according to changes in an external environment; and a first analog frontend (e.g., the analog frontend 104) coupled to the first sensor and configured to generate a first analog output corresponding to the first analog signal. The second input node comprising: a second sensor (e.g., the sensor 102) configured to output a second analog signal according to changes in the external environment; and a second analog frontend (e.g., the analog frontend 104) coupled to the second sensor and configured to generate a second analog output corresponding to the second analog signal. Each input node is sometimes referred to as a neuron (e.g., an analog neuron). The array of input nodes represents an input layer for the MAC circuit. In some embodiments, the first analog frontend is configured to adjust one or more properties of the first analog signal and the second analog frontend is configured to adjust one or more properties of the second analog signal. Each analog frontend outputs an analog signal (e.g., does not include an analog-to-digital converter). For example, the set of MAC components may include one or more separate MAC components.

(A2) In some embodiments of A1, the set of MAC components comprises two or more separate MAC components, each MAC component of the two or more separate MAC components coupled to a respective input node of the array of input nodes. For example, each separate MAC component may be configured for a specific sensor type.

(A3) In some embodiments of A1 or A2, the first analog frontend comprises a transformer (e.g., the transformer 106) configured to convert a voltage from the first sensor. In some embodiments, the first analog signal is an alternating current (AC) signal. For example, the transformer steps down or up an AC voltage from the one or more sensors. In some embodiments, each analog frontend includes a transformer. In some embodiments, the transformer is configured to adjust the voltage from the first sensor to be within a predetermined range (e.g., between 5 volts and −5 volts or between 10 volts and −10 volts). In some embodiments, a precision of the transform is selected/adjusted based on the type of sensor, the sensing environment, and/or the object being sensed.

(A4) In some embodiments of any of A1-A3, the first analog frontend comprises a spiking circuit (e.g., the spiking circuit 110) configured to generate one or more voltage or current spikes corresponding to the first analog signal from the first sensor. For example, the spiking circuit converts a continuous AC signal to a DC signal (e.g., representing maximums and/or minimums in the AC signal). In some embodiments, each analog frontend includes a spiking circuit. In some embodiments, the spiking circuit comprises a set of resistors and a diode. In some embodiments, the spiking circuit is configured to generate a spike corresponding to a peak-to-peak amplitude of the first analog signal.

(A5) In some embodiments of A4, the first analog frontend further comprises a filtering component (e.g., the filter 112) coupled to the spiking circuit and configured to filter out portions of the one or more voltage or current spikes. For example, the filtering component may be a high pass filter, a low pass filter, or a band pass filter. In some embodiments, the filtering component is configured to filter out noise in the signal from the spiking circuit (e.g., errant spikes that do not correlate to a component being sensed by the first sensor).

(A6) In some embodiments of any of A1-A5, the first analog frontend comprises a storage element (e.g., the storage component 120-1) configured to store a charge corresponding to the first analog signal. For example, the storage element is configured to store a charge corresponding to a voltage spike from the spiking circuit. In some embodiments, the storage element is a capacitor (e.g., a super capacitor or other temperature-invariant capacitor). In some embodiments, the storage element is a memory element (e.g., a non-volatile memory cell). For example, the storage element may be an EEPROM or flash element. In some embodiments, each analog frontend includes a storage element. In some embodiments, storing the charge corresponding to the first analog signal comprises replacing a previous charge (e.g., that corresponds to a previous signal from the first sensor).

(A7) In some embodiments of A6, the set of MAC components is configured to interpret the stored charge as a weight associated with the first input node. In some embodiments, the set of MAC components generates a combined signal (e.g., sums) from the stored charges corresponding to an array of sensors. In some embodiments, the set of MAC components comprises a rectified linear unit (ReLU). For example, the ReLU receives the combined signal and generates a corresponding output (used by the classification component). In some embodiments, the classification component includes the ReLU.

(A8) In some embodiments of A6 or A7, the first analog frontend further comprises a second storage element configured to store a reference charge for the first sensor. In some embodiments, the reference charge corresponds to a baseline (ground truth) value for the first sensor. In some embodiments, the reference charge corresponds to an initial state for the first sensor. For example, the initial state may be determined during fabrication and/or testing of the first sensor. In some embodiments, the reference charge corresponds to a previous state for the first sensor. For example, the previous state may be determined during a previous use of the first sensor.

(A9) In some embodiments of any of A1-A8, at least one of the first sensor and the second sensor comprises: a strain sensor, a magnetoresistive sensor, an infrared sensor, a vibration sensor, a temperature sensor, an accelerometer, or an acoustic sensor.

(A10) In some embodiments of any of A1-A9, the first sensor is a first type of sensor, and the second sensor is a second type of sensor, different from the first type of sensor.

(A11) In some embodiments of any of A1-A10, the set of MAC components comprises a set of hidden layers. For example, the set of MAC components may comprise a neural network, such as a convolutional neural network (CNN) or an analog neural network (ANN).

(A12) In some embodiments of any of A1-A11, at least one of the first sensor and the second sensor is a reference sensor. For example, a reference node may have the same components as an input node, but the sensor component measures a reference or baseline condition. As an example, an input sensor may be attached to a wheel of a vehicle and a reference sensor may be attached to a chassis of the vehicle. As another example, an input sensor may be positioned to measure a signal output from a target device and a reference sensor may be positioned to measure an ambient signal from the environment. In some embodiments, at least one of the first sensor and the second sensor corresponds to a respective energy harvesting component. For example, the first sensor and/or the second sensor may comprise a piezoelectric sensor.

(A13) In some embodiments of any of A1-A12, the system further includes a controller configure to adjust a set of weights corresponding to the first input node and the second input node based on the one or more outputs of the set of MAC components. For example, the controller may be an edge compute controller such as a CPU, MCU, GPU, or TPU. In some embodiments, the controller adjusts the set of weights based on a loss function for the one or more outputs of the set of MAC components. In some embodiments, the set of weights are stored at the input nodes. In some embodiments, the set of weights are stored in the set of MAC components.

(A14) In some embodiments of any of A1-A13, the system further includes an output component coupled to the classification component and configured to initiate an action based on classification of the one or more outputs of the set of MAC components. For example, the system may be a vehicular system and the action may include adjusting a speed of the vehicle, adjusting an acceleration of the vehicle, and/or generating a notification about driving conditions (e.g., surface conditions and/or operating conditions) for the vehicle. Example driving conditions include tire pressure, tire thread width, tire load, vehicle balance, surface friction, and operating temperature.

(A15) In some embodiments of any of A1-A14, the first sensor is wirelessly coupled to the first analog frontend. In some embodiments, the first input node and the second input node are wirelessly coupled to the set of MAC components. For example, the first input node and the second input node may be coupled to the MAC components via a wireless mesh network.

(B1) In another aspect, some embodiments include a sensor node (e.g., the sensor module 100) that comprises: (i) a sensor (e.g., the sensor 102) configured to sense a property of a target object and output a corresponding analog signal; (ii) a transformer (e.g., the transformer 106) coupled to the sensor and configured to adjust a voltage or current level of the corresponding analog signal from the sensor; and (iii) a spiking circuit (e.g., the spiking circuit 110) coupled to the transformer and configured to generate a voltage or current spike corresponding to the corresponding analog signal. In some embodiments, the sensor is an energy harvesting sensor. In some embodiments, the sensor is piezoelectric sensor, a magnetic sensor, an infrared sensor, or an acoustic sensor. In some embodiments, the target object comprises a magnet.

(B2) In some embodiments of B1, the sensor node further includes a rectifier (e.g., the rectifier 106) coupled to an output of the transformer and configured to convert the output to a direct current (DC) analog signal, where the spiking circuit is coupled to the transformer via the rectifier and is configured to generate the spike using the DC analog signal. In some embodiments, the rectifier comprises a set of diodes.

(B3) In some embodiments of B1 or B2, the sensor node further includes a capacitor (e.g., the storage component 120-1) configured to store a charge corresponding to the spike generated by the spiking circuit.

(C1) In another aspect, some embodiments include a method (e.g., the method 300) that comprises: (i) receiving a first analog signal from a first sensor (e.g., a first instance of the sensor 102); (ii) receiving a second analog signal from a second sensor (e.g., a second instance of the sensor 102); (iii) generating, via a first analog component (e.g., a first instance of the analog frontend 104), a first analog output based on the first analog signal; (iv) generating, via a second analog component (e.g., a second instance of the analog frontend 104), a second analog output based on the second analog signal; (v) generating, via a MAC component (e.g., the MAC component(s) 122), a compute signal by multiplying and accumulating the first analog output and the second analog output; (vi) determining a state of an object based on the compute signal (e.g., using the classifier 124); and (vii) initiating an action based on the state of the object.

(C2) In some embodiments of C1, initiating the action comprises one or more of: generating a notification regarding the state of the object, and adjusting the state of the object. For example, adjusting a speed of the object, an acceleration of the object, and orientation of the object, an operating state of the object, or other state of the object.

It will be understood that, although the terms first, second, etc. may be used herein to describe various elements, these elements should not be limited by these terms. These terms are only used to distinguish one element from another. For example, a first array could be termed a second array, and, similarly, a second array could be termed a first array, without departing from the scope of the various described embodiments. The first array and the second array are both arrays, but they are not the same array.

The terminology used in the description of the embodiments herein is for the purpose of describing particular embodiments only and is not intended to be limiting of the scope of claims. As used in the description and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Reference has been made to embodiments, examples of which are illustrated in the accompanying drawings. In the forgoing description, numerous specific details have been set forth in order to provide a thorough understanding of the various described embodiments. However, it will be apparent to one of ordinary skill in the art that the various described embodiments may be practiced without these particular details. In other instances, methods, procedures, components, and circuits that are well-known to those of ordinary skill in the art are not described in detail so as not to unnecessarily obscure aspects of the embodiments.

The foregoing description, for purpose of explanation, has been described with reference to specific embodiments. However, the illustrative discussions above are not intended to be exhaustive or to limit the scope of claims to the precise forms disclosed. Many modifications and variations are possible in view of the above teachings. The embodiments were chosen and described in order to best explain the principles of the various described embodiments and their practical applications, to thereby enable others skilled in the art to best utilize the principles and the various described embodiments with various modifications as are suited to the particular use contemplated.

1. A system, comprising:
an array of input nodes comprising a first input node and a second input node;
the first input node comprising:
a first sensor configured to output a first analog signal according to changes in an external environment; and
a first analog frontend coupled to the first sensor and configured to generate a first analog output corresponding to the first analog signal;
the second input node comprising:
a second sensor configured to output a second analog signal according to changes in the external environment; and
a second analog frontend coupled to the second sensor and configured to generate a second analog output corresponding to the second analog signal;
a set of multiply accumulate compute (MAC) components coupled to the first input node and the second input node and configured to multiply and accumulate the first analog output and the second analog output; and
a classification component coupled to one or more outputs of the set of MAC components and configured to classify the one or more outputs of the set of MAC components.

2. The system of claim 1, wherein the set of MAC components comprises two or more separate MAC components, each MAC component of the two or more separate MAC components coupled to a respective input node of the array of input nodes.

3. The system of claim 1, wherein the first analog frontend comprises a transformer configured to convert a voltage from the first sensor.

4. The system of claim 1, wherein the first analog frontend comprises a spiking circuit configured to generate one or more voltage or current spikes corresponding to the first analog signal from the first sensor.

5. The system of claim 4, wherein the first analog frontend further comprises a filtering component coupled to the spiking circuit and configured to filter out portions of the one or more voltage or current spikes.

6. The system of claim 1, wherein the first analog frontend comprises a storage element configured to store a charge corresponding to the first analog signal.

7. The system of claim 6, wherein the set of MAC components is configured to interpret the stored charge as a weight associated with the first input node.

8. The system of claim 6, wherein the first analog frontend further comprises a second storage element configured to store a reference charge for the first sensor.

9. The system of claim 1, wherein at least one of the first sensor and the second sensor comprises: a strain sensor, a magnetoresistive sensor, an infrared sensor, a vibration sensor, a temperature sensor, an accelerometer, or an acoustic sensor.

10. The system of claim 1, wherein the first sensor is a first type of sensor, and wherein the second sensor is a second type of sensor, different from the first type of sensor.

11. The system of claim 1, wherein the set of MAC components comprises a set of hidden layers.

12. The system of claim 1, wherein at least one of the first sensor and the second sensor is a reference sensor.

13. The system of claim 1, further comprising a controller configured to adjust a set of weights corresponding to the first input node and the second input node based on the one or more outputs of the set of MAC components.

14. The system of claim 1, further comprising an output component coupled to the classification component and configured to initiate an action based on classification of the one or more outputs of the set of MAC components.

15. The system of claim 1, wherein the first sensor is wirelessly coupled to the first analog frontend.

16. A sensor node, comprising:
a sensor configured to sense a property of a target object and output a corresponding analog signal;
a transformer coupled to the sensor and configured to adjust a voltage or current level of the corresponding analog signal from the sensor; and
a spiking circuit coupled to the transformer and configured to generate a voltage or current spike corresponding to the corresponding analog signal.

17. The sensor node of claim 16, further comprising a rectifier coupled to an output of the transformer and configured to convert the output to a direct current (DC) analog signal, wherein the spiking circuit is coupled to the transformer via the rectifier and is configured to generate the spike using the DC analog signal.

18. The sensor node of claim 16, further comprising a capacitor configured to store a charge corresponding to the spike generated by the spiking circuit.

19. A method, comprising:
receiving a first analog signal from a first sensor;
receiving a second analog signal from a second sensor;
generating, via a first analog component, a first analog output based on the first analog signal;
generating, via a second analog component, a second analog output based on the second analog signal;
generating, via a multiply accumulate compute (MAC) component, a compute signal by multiplying and accumulating the first analog output and the second analog output;
determining a state of an object based on the compute signal; and
initiating an action based on the state of the object.

20. The method of claim 19, wherein initiating the action comprises one or more of:
generating a notification regarding the state of the object, and adjusting the state of the object.
